(19) United States
(12) Patent Application Publication
(10) Pub. No.: US 2006/0188081 A1
(43) Pub. Date: Aug. 24, 2006

(54) Systems and methods for call measurement

(76) Inventors: Murray Hooper, Cambridge (CA); Shane O'Neil, Woodbridge (CA)

Correspondence Address: BERESKIN AND PARR, 40 KING STREET WEST, BOX 401, TORONTO, ON, M5H 3Y2, CA

(21) Appl. No.: 11/354,817

(22) Filed: Feb. 16, 2006

Related U.S. Application Data
(60) Provisional application No. 60/654,006, filed on Feb. 18, 2005.

(51) Int. Cl. H04M 15/06; H04M 3/42

(52) U.S. Cl. 379/211.02; 379/142.01

(57) ABSTRACT

Systems and methods for call measurement services. The system includes a routing system, a client database, and a call block database. The routing system is configured to receiving an incoming call containing incoming call data which may include an original dialed number and a caller identifier. The client database stores at least one published number and at least one termination number, wherein each termination number corresponds to at least one published number. The call block database stores at least one blocked number. The routing system is operatively coupled to the client database and to the call block database and wherein the routing system is configured to route the incoming call to one of the termination numbers. Blocked numbers may be added to the call block database when telemarketing calling patterns are detected.

### CONTINUITY

This application is a continuation of U.S. patent application No. 60/654,006 filed Feb. 18, 2005 which is incorporated in its entirety herein by reference.

### FIELD OF THE INVENTION

The present invention relates generally to the field of telecommunications, with common but by no means exclusive application to measuring the effectiveness of advertising media by counting the number of telephone calls made in response to a particular advertisement.

### BACKGROUND OF THE INVENTION

There is a growing need for business to justify their advertising expenditures. Businesses must evaluate the response to a marketing initiative, in order to determine if their marketing dollars are being spent wisely.

However, counting the number of telephone calls to a company may not provide an accurate measurement of the success of the marketing initiative. Telemarketing calls and other calls unrelated to an advertisement will skew the data.

Accordingly, the inventors have recognized a need for systems and methods for screening telemarketing calls. The inventors have also recognized a need for improved systems and methods for call measurement in response to advertising.

### SUMMARY OF THE INVENTION

In one aspect, the present invention is directed towards a call measurement system having a routing system, a client database, and a call block database. The routing system is configured to receiving an incoming call comprising incoming call data which may include an original dialed number and a caller identifier. The client database stores at least one published number and at least one termination number, wherein each termination number corresponds to at least one published number. The call block database stores at least one blocked number. The routing system is operatively coupled to the client database and to the call block database and wherein the routing system is configured to route the incoming call to one of the termination numbers.

In another aspect, the present invention is directed towards a method of routing incoming calls comprising incoming call data, wherein the incoming call data includes, original dialed number data and caller identifier data, the steps of the method comprising:
(a) providing a client database storing:
   (i) at least one published number;
   (ii) at least one termination number, wherein each termination number corresponds to at least one published number;
(b) providing a call block database storing call block data corresponding to at least one blocked number;
(c) receiving an incoming call; and
(d) comparing the caller identifier data to the call block data and if the caller identifier data does not correspond to a blocked number, routing the incoming call to a termination number.

In yet a further aspect, the present invention is directed towards a method of creating a call block database comprising the following steps:
(a) providing a client database storing:
   (i) a plurality of published numbers; and
   (ii) a plurality of termination numbers, wherein each published number corresponds to at least one termination number;
(b) providing a call block database storing at least one blocked number;
(c) receiving a plurality of incoming calls comprising incoming call data, wherein the incoming call data includes an original dialed number and a caller identifier;
(d) storing incoming call data for each incoming call in an incoming call database; and
(e) searching the incoming call data in the incoming call database to locate telemarketing calling patterns.

In another aspect, the present invention is directed towards a method of routing incoming calls comprising incoming call data through a telecommunications system, wherein the incoming call data includes original dialed number data and caller identifier data, and wherein the telecommunications system includes a client database storing at least one published number and at least one termination number, wherein each termination number corresponds to at least one published number. The steps of the method comprise:
(a) providing a call block database storing call block data corresponding to at least one blocked number;
(b) receiving an incoming call; and
(c) comparing the caller identifier data to the call block data and if the caller identifier data does not correspond to a blocked number, routing the incoming call to a termination number.

### BRIEF DESCRIPTION OF THE DRAWINGS

The present invention will now be described, by way of example only, with reference to the following drawings, in which like reference numerals refer to like parts and in which:

FIG. 1 is a schematic diagram of a call measurement system made in accordance with the present invention.

FIG. 2A is a schematic diagram of example incoming call data, as may be transmitted to the call measurement system of FIG. 1 when a calling party initiates a telephone call;

FIG. 2B is a schematic diagram of example of valid combinations of NPA-NXX data, as may be stored in an NPA-NXX database of the call measurement system of FIG. 1;

FIG. 3 is a diagram of an example advertisement containing an example published number, as may be used in conjunction with the call measurement system of FIG. 1,

FIG. 4 is a schematic diagram of example client data records, as may be stored in a client database of the call measurement system of FIG. 1;

FIG. 5 is a schematic diagram of example call tracking data records, as may be stored in a call tracking database of the call measurement system of FIG. 1;

FIG. 6 is a schematic diagram of example white list data records, as may be stored in a white list database of the call measurement system of FIG. 1;

FIG. 7 is a schematic diagram of example call block data records, as may be stored in a call block database of the call measurement system of FIG. 1; and

FIGS. 8A-8C are flow diagrams illustrating the steps of methods of the present invention.

### DETAILED DESCRIPTION OF THE INVENTION

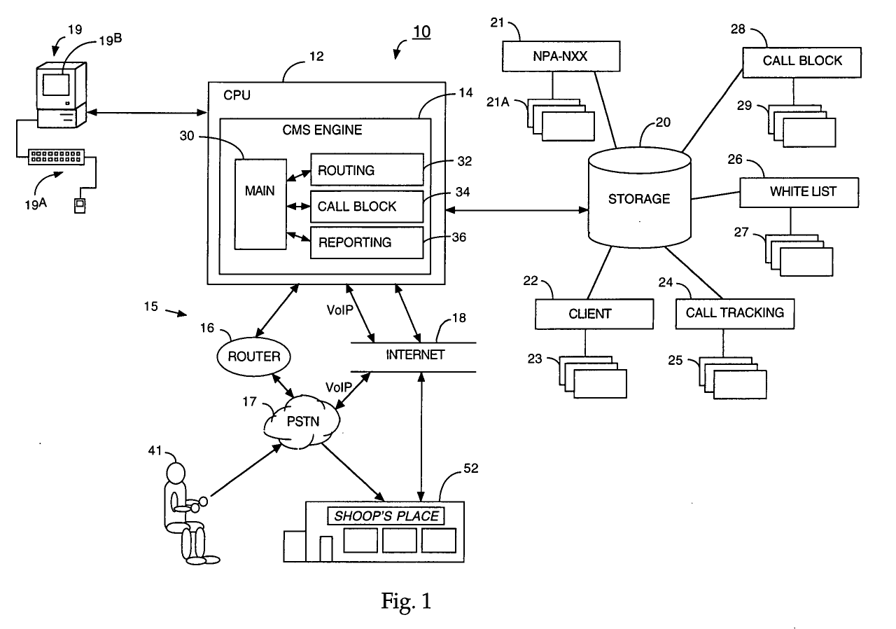

Referring to FIG. 1, illustrated therein is a call measurement system (CMS), referred to generally as 10, made in accordance with the present invention. The CMS 10 comprises a processor or central processing unit (CPU) 12 such as a standard personal computer (PC) running on a WINDOWS™ operating system and having a suitably programmed CMS engine 14.

A routing system 15 is also provided which is capable of receiving incoming calls and routing them through outgoing calls and will preferably include a telephony router 16 operatively coupled to the CPU 12 and configured for receiving and placing telephone calls via the public switch telephone network (PSTN) 17. The CPU 12 will also preferably be operatively coupled to the internet 18 or other data network for the exchange of data including the receiving and placing of telephone calls for example using voice over internet protocol (VoIP)—as will be understood, the software and hardware components capable of initiating and receiving calls using VoIP may comprise part of the routing system 15. An input/output device 19 (typically including an input component 19^{A} such as a keyboard, and output components such as a display 19^{B}) is also operatively coupled to the CPU 12.

Data storage 20 is also provided, although as will be understood, the storage 20 may be local to or remote from the CPU 12 and portions of the data stored may be stored in different physical or electronic storage locations. The data storage 20 will preferably include an NPA-NXX database 21 storing NPA-NXX data records 21A corresponding to valid NPA-NXX combinations, a client database 22 storing client data records 23, a call tracking database 24 storing tracked call data 25, a white list database 26 storing white list data 27 and a call block database 28 storing call block data 29. As will be understood the data may be stored in different configurations than illustrated herein for explanatory purposes.

The CMS engine 14 may include several modules. A main executable module 30 is preferably provided for controlling the operation of the various sub-modules: a routing module 32, a call block module 34, and a reporting module 36.

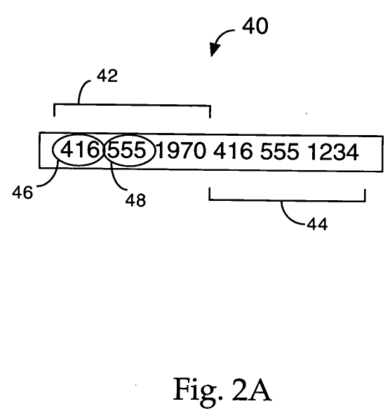

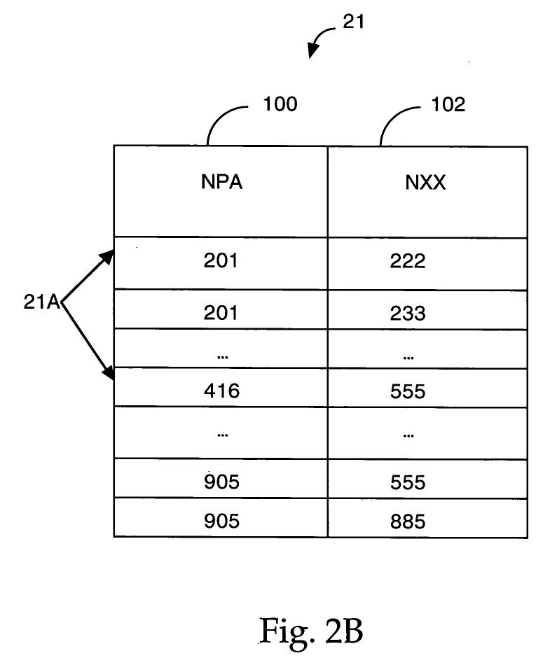

Referring briefly to FIG. 2A, illustrated therein is sample incoming call data 40 which is typically transmitted when a phone call is initiated by a caller 41. Data other than what is illustrated and described may also be transmitted. The incoming call data 40 typically includes the caller ID number (CLID) 42 or phone number from where the call was initiated, together with the original dialed number (ODN) 44, and the numbering plan area (NPA) 46 and numeric numbering exchange (NXX) 48 segments of the CLID 42.

The routing module 32 may comprise part of the routing system 15 and is configured to receive the incoming call data 40 typically and determine how the incoming call 40 should be handled. The blacklist or call block module 34 manages the call block database 28 which stores call block data 29 including data correlated to phone numbers which are to be blocked. The reporting module 36 is typically accessed by clients via the internet 18, and generates reports on calling activity to the client based on tracked call data 25 stored in the call tracking database 24.

As will be understood, local and toll-free telephone numbers can be obtained from local exchange carriers (LECs) and can be remote call forwarded from the LEC's telephony infrastructure. Accordingly, telephone numbers can be acquired from LECs such that telephone calls placed to those acquired numbers will be forwarded to the system 10.

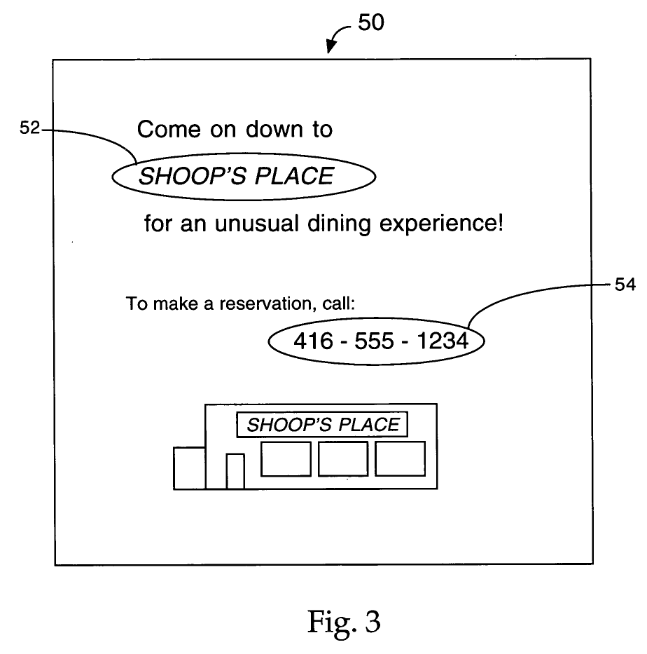

In turn, these acquired numbers can be assigned to advertising clients to be published or otherwise used in advertising initiatives (such as television or radio ads, printed advertising, billboard ads, etc.) (all referred to herein as “published”). For example, as illustrated in FIG. 3, an advertisement 50 for a client 52 would display or otherwise indicate an acquired number referred to herein as a published number 54, in place of the client's 52 standard business phone number.

Those skilled in the art can appreciate that any combination of technologies may be available where the inbound call 40 may be received by the CMS 10 via the PSTN 17 (TDM) or VoIP (SIP/H.323) methodologies. In addition, the CMS 10 is preferably indifferent to the caller's 41 or client's 52 choice of service to create or receive calls via Plain Old Telephone Service (POTS) or via a VoIP service provider. The CMS 10 can route a call 40 to a gateway which will determine the best route for delivering the call 40 to the client 52. Those skilled in the art can also appreciate that there are existing and emerging technologies for telephony communication and that the spirit and intention of the present invention is to include the application of existing and emerging telephony technologies.

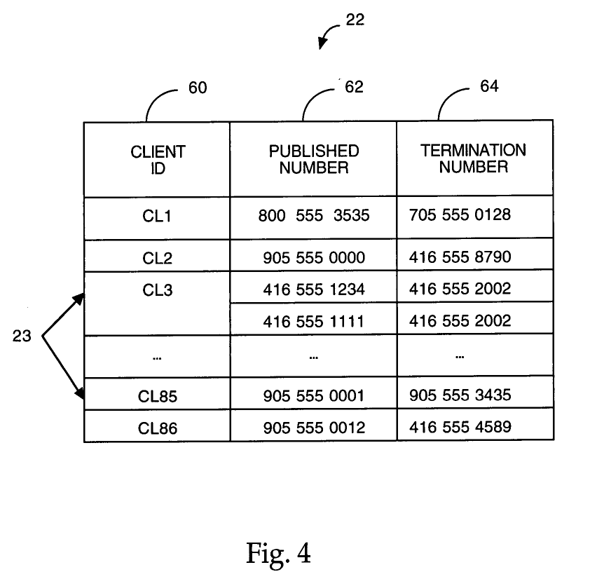

Referring now to FIG. 4, illustrated therein is an example of the type of client records 23 data typically stored in the client database 22. Typically the client records 23 data will be determined and input into the database 22 by a system 10 administrator, when clients 52 “sign up” for call measurement services provided by the system 10 upon commencement of an advertising initiative.

Each client record 23 will typically include unique client identifier data 60 corresponding to a client 52, as well as published number data 62 corresponding to the phone numbers assigned to the client's various advertising initiatives. More than one published number 62 may be assigned to a specific advertising initiative for a client 52, 60, but preferably each published number 62 only corresponds to one advertising initiative in order to be able to more accurately track a specific advertising initiative's efficacy.

Client records 23 will also include the client's 52, 60 normal business phone number or termination number 64. While a client 52, 60 may have a plurality of business phone numbers, typically each published number 62 will correspond to only one termination number 64. However, it is not uncommon for more than one published number 62 to correspond to the same termination number 64 so that the responses to different advertising initiatives for the same client 52, 60 can be tracked.

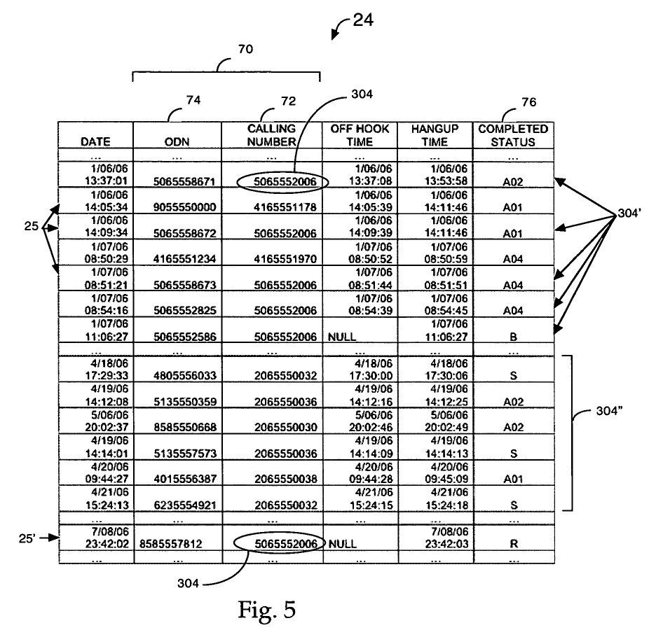

Referring now to FIG. 5, illustrated therein is an example of the type of tracked call records 25 data typically stored in the call tracking database 24. As each phone call 40 is received and handled by the system 10, tracked call records 25 data corresponding to the phone call 40 and its disposition is stored in the tracked call records 25. The tracked call records 25 may include additional data such as the time the call was initiated, the duration of the call, how many rings occurred before the call was answered, or other data that may be used to measure performance or other aspects of the telephone calls 40.

Each tracked call record 25 will typically include incoming call data 40, 70 (such as CLID 72 and ODN 74), as well as call disposition data 76 containing a code corresponding to how the call was completed or handled. For example, the call disposition data 76 may indicate that the call was answered, unanswered, blocked, or a busy signal was returned. While it will be understood that other codes may be used to provide a variety of desired information about the handling of telephone calls 40, the call disposition data 76 in FIG. 5 may indicate for example with an “A” plus a ring count that the call was answered after a certain number of rings (eg. “A04” may indicate that the call was answered after 4 rings). Similarly, a “B” code may indicate that the termination number was busy. An “N” plus a ring count may indicate that the call was not answered and the caller 41 hung up after a certain number of rings (eg. “N06” may indicate that the caller 41 hung up after 6 rings). Similarly, an “R” code may indicate that the call 40 was rejected or call blocked, as will be discussed in greater detail, below.

As will be understood, the CMS 10 is configured and programmed to permit a client 52 to interact with the reporting module 36 via the Internet 18 using Transmission Control Protocol/Internet Protocol (TCP/IP). The CMS 10 may be contacted using hypertext transport protocol in a secure or unsecured method (HTTP/HTTPS) to obtain call measurement reports generated by the reporting module 36 based on the data records 25 in the tracked call database 24. In addition the CMS 10 may send such reports to the client 52 via the Internet 18 using email via the Simple Mail Transfer Protocol (SMTP).

The CMS 10 reports will typically include data points that are considered important to advertising clients 52 such as CLID 42, 74, date/time of call 40, ODN 44, 74, answer status (Busy, Not Answered, or Answered in X number of rings), call duration, name and address of calling party 41 (usually determined by cross-referencing the CLID 42 to a telephone directory database, as will be understood), Do Not Call Registry Status of Calling Party 41, distance from client's 52 location of the CLID handset and demographic information regarding the calling party 41, depending on which data is tracked and stored in the call tracking database 24. Call block reporting includes the call details of CLIDs 42, 74 that have been blocked because they appeared on the “global black list” or the client's 52 individualized black list 29′″ as well as CLIDs 42 that have been allowed that are on the client's 52 individual white list 27′″ (as explained in greater detail below).

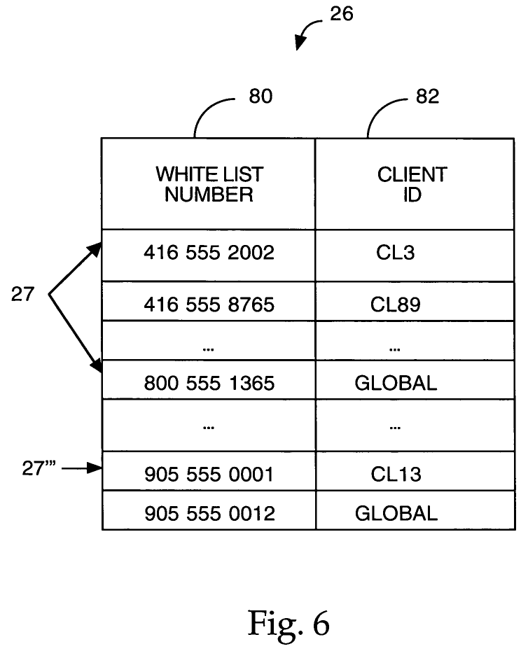

Referring now to FIG. 6, illustrated therein is an example of the type of white list data 27 typically stored in the white list database 26. Typically the white list data 27 includes white list CLIDs 80 corresponding to telephone numbers which conform to NANP standards. The white list data 27 will typically also include a client identifier data 82 corresponding to and providing a link to the client identifier data 60 stored in the client data records 23.

Incoming calls 40 containing CLIDs 42 matching the CLIDs 80 on a client's 52 individual white list 27′″ are not prevented by the system 10 from being routed to termination numbers 64 corresponding to the client's 52 indentifier 82, 60. The client identifier data 82 may also store global indicator data such as “GLOBAL” which the system 10 recognizes as indicating that the incoming calls 40 containing CLIDs 42 matching the CLIDs 80 on the white list are not prevented by the system 10 from being routed to any termination numbers 64 (in effect creating a global white list).

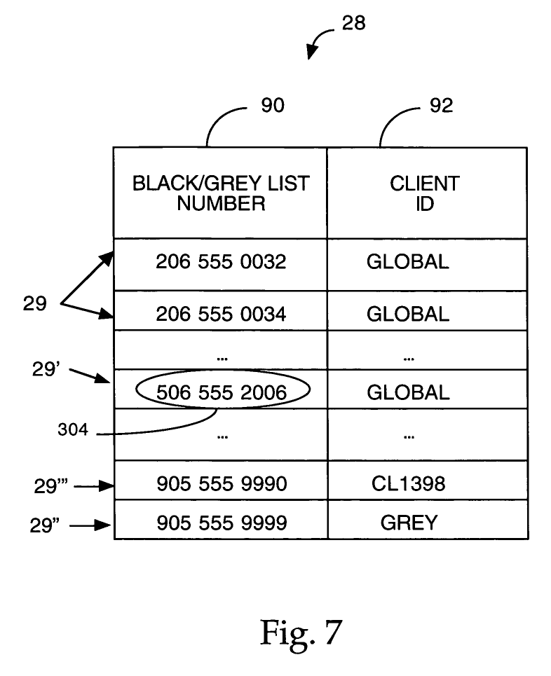

Referring now to FIG. 7, illustrated therein is an example of the type of call block data 29 typically stored in the call block database 28. Typically the call block data 29 includes black list CLIDs 90 corresponding to telephone numbers which conform to NANP standards. The black list data 29 will typically also include a client identifier data 92 corresponding to and providing a link to the client identifier data 60 stored in the client data records 23.

Incoming calls 40 containing CLIDs 42 matching the CLIDs 90 on the black list are blocked by the system 10 from being routed to termination numbers 64 corresponding to the client indentifier 82, 60. The client identifier data 92 may also store global indicator data such as “GLOBAL” which the system 10 recognizes as indicating that the incoming calls 40 containing CLIDs 42 matching the CLIDs 90 on the black list are blocked by the system 10 from being routed to any termination numbers 64 (in effect creating a global black or suppression list). As will be discussed below, the call block data 29 is typically stored and updated by the call block module 34 during the normal operation of the system 10 or directly by clients 82, 60 as phone calls 40 routed through the system 10 are received by clients 82, 60.

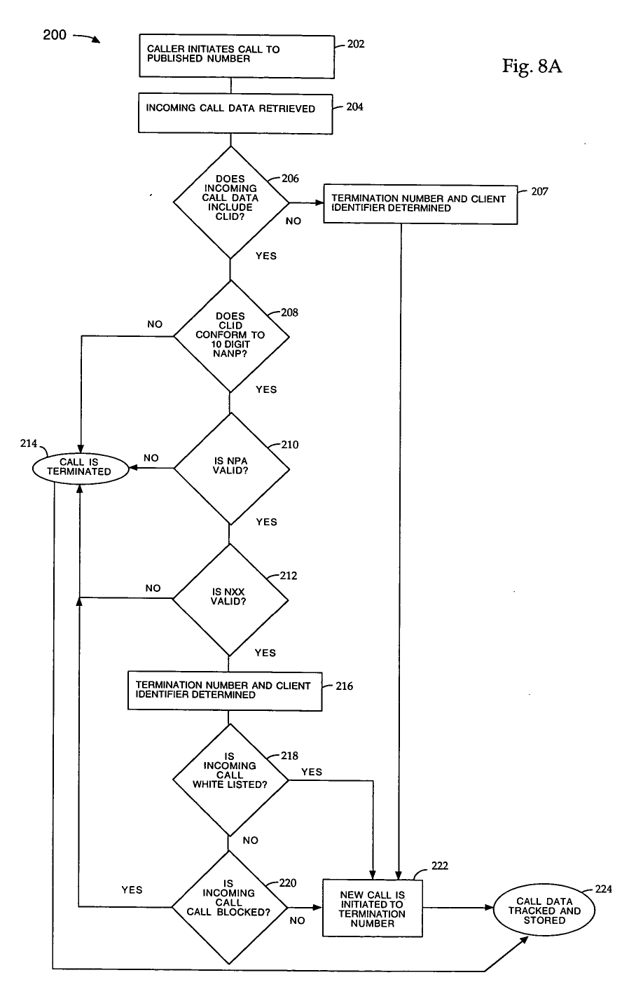

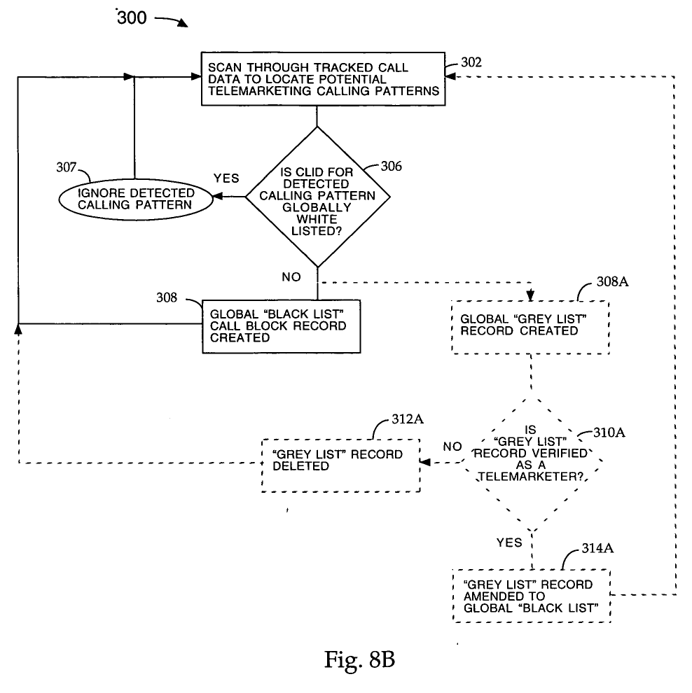

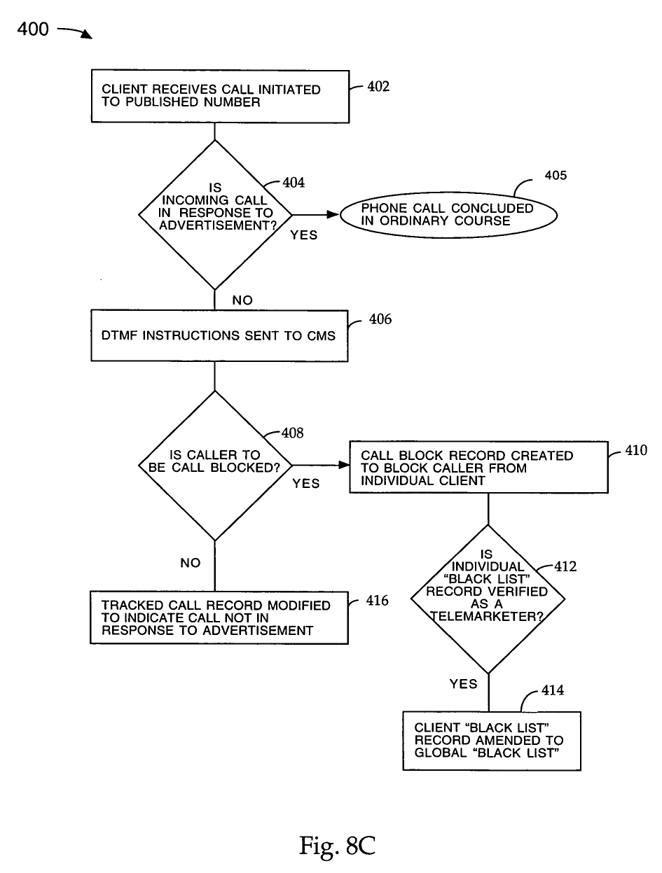

Referring now to FIG. 8A, this figure is a flow chart setting out the process 200 carried out by the routing module 32. Initially, a caller 41 initiates a telephone call typically via the PSTN 17 to a published telephone number 54 (such as the published number 54 displayed in the example advertisement 50) (Block 202). As previously noted, the published number 54 has been acquired from an LEC that provides RCF service through the PSTN 17. Each telephone number acquired is set up with the LEC to RCF incoming calls to the system's telephony router 16. When the caller's 41 call 40 is received by the telephony router 16, the routing module 32 retrieves the incoming call data 40 (Block 204).

The routing module 32 first determines if the incoming call data 40 includes a CLID 42 (Block 206). As will be understood, in some instances, an incoming call will not include a CLID 42. For example, the caller identity may have been blocked by the request of the caller 41 having a caller privacy feature (such as “*69”) enabled through his or her telephone company (Telco). Alternatively, the Telco may be unable to provide CLID information for a call 40. If a CLID 42 is unavailable, the routing module 32 then determines the ODN 44 from the incoming call data 40 and matches the ODN 44 to a published number 62 to determine the corresponding termination number 64 and client identifier 60 from the client database 22 (Block 207). The routing module 32 then initiates a new call to the termination number 64 to which the incoming call 40 is connected, as discussed in relation to Block 222, below.

If a CLID 42 has been provided with the incoming call data 40, the routing module 32 will then verify if the CLID 42 conforms to the 10 digit NANP (Block 208).

Referring briefly to FIG. 2B, illustrated therein is an example of the type of NPA-NXX records 21A data typically stored in the NPA-NXX database 21. Typically the NPA-NXX records 21A data will be determined and input into the database 21 by a system 10 user. The NPA-NXX records 21A typically include valid NPA 100 and NXX 102 combinations.

Next, the routing module 32 will search the NPA/NXX database records 21A to determine if the NPA data 46 provided with the incoming call data 40 contains a corresponding match in the records 21A and hence is valid (Block 210). If the NPA 46 is valid, the routing module 32 will also search the NPA-NXX database records 21A to determine if the NXX data 48 is valid (Block 212). As will be understood, the NPA 46 and NXX 48 data must match an NPA 100 and NXX 102 combination in the NPA-NXX database records 21A in order for the NPA 46 and NXX 48 data to be valid.

As illustrated on FIG. 8A, if at any step the CLID fails a test set out in Blocks 208, 210, or 212, the call is disconnected or otherwise terminated (Block 214) and a DISCONNECT message with CAUSE_CODE 1 ‘Unallocated Number’ (which is a standard LEC response code) which causes the switch on the PSTN 17 nearest to the caller 41 to play the appropriate tone or message that the call 40 cannot be completed.

The routing module 32 then determines the ODN 44 from the incoming call data 40 and matches the ODN 44 to a published number 62 to determine the corresponding termination number 64 and client identifier 60 from the client database 22 (Block 216).

The routing module 32 queries the white list database 26 to determine if a white list record 27 exists containing a white list CLID 80 matching the incoming call CLID 42 and which either has a client identifier 82 containing a global indicator (such as “GLOBAL”) or matching the client identifier data 60 determined in Block 216 (Block 218).

If the incoming call 40 is not “white listed”, the routing module 32 queries the call block database 28 to determine if a call block record 29 exists containing a black list CLID 90 matching the incoming call CLID 42 and which either has a client identifier 92 containing a global indicator (such as “GLOBAL”) or matching the client identifier data 60 determined in Block 216 (Block 220). If the caller 41 is either globally call-blocked or call-blocked for the particular client 60 to whom the incoming call 40 is directed, the call is terminated in accordance with Block 214 as discussed above.

If the incoming call 40 is “white listed” or not call-blocked, the routing module 32 initiates a new call to the termination number 64 determined in Block 216 (or Block 207 as appropriate) to which the incoming call 40 is connected (Block 222). It should be understood herein that the new call may typically be initiated via the PSTN 17 or via the Internet 18 through a VoIP gateway to the PSTN 17, but other communications networks or systems may be used as appropriate. As will be understood, by initiating a new call, the system 10 is able to track the state of the call 40. During the operation of the system 10, for each incoming call 40 received, the routing module 32 preferably creates a tracked call record 25 in the call tracking database 24, to store data corresponding to the disposition of the call 40 (Block 224).

Referring now to FIG. 8B, this figure is a flow chart setting out a process 300 carried out by the call block module 34. Periodically, during the operation of the system 10, the call block module 34 will preferably search or scan through previously unscanned tracked call records 25 in the call tracking database 24 to locate calling patterns indicative of telemarketing activity (Block 302). The call block module 34 is programmed to recognize telemarketing calling patterns, as will be understood.

For example, as illustrated on FIG. 5, potential telemarketer 304 having a CLID 72 value of “506 555 2006” may be indicated by telemarketing pattern 304′ on several tracked call records 25 (all sharing the same CLID 72) as having placed a series of calls 40 to sequential or numerically proximate ODNs 44, 74. Additionally, a high volume of calls to ODNs 44, 74 by a CLID 72 may also be a pattern indicative of a telemarketer.

Similarly, as illustrated on FIG. 5, potential telemarketing activity 304″ may be indicated in several tracked call records 25 (all sharing numerically proximate CLIDs 72, suggesting a block of telephone numbers being used by a telemarketing company) as having placed a high volume of calls to ODNs 44, 74.

As will be understood, the volume of calls to different ODNs 44, 74 before the call block module 34 will flag a CLID 72 (or block of numerically close CLIDs 72) as a telemarketer will vary depending on the volume of published numbers 62 in the client database 22 and other established norms.

Upon detecting a telemarketing calling pattern, the call block module 34 queries the white list database 26 to determine if a white list record 27 exists containing a white list CLID 80 matching the CLID(s) 72 identified in Block 302 and which has a client identifier 82 containing a global indicator (such as “GLOBAL”) (Block 306). This could happen, for example, if the administrator of the system 10 intended to make phone calls to a number of published numbers 62 for quality control purposes and the administrator ensured that his/her telephone number was globally “white listed”. If such a white list record 27 exists, the potential telemarketer calling pattern is ignored (Block 307), and the call block module 34 searches for the next telemarketer calling pattern in Block 302.

If the CLID 72 is not globally “white listed”, the call block module 34 creates a call block record 29 containing CLID 90 data matching the CLID 72 identified in Block 302 together with a client identifier 92 containing a global call block indicator (such as “GLOBAL”) (Block 308) and the call block module 34 searches for the next telemarketer calling pattern in Block 302. As illustrated in FIG. 7, a call block record 29′ has been created for telemarketer 304 as a result of telemarketing activity 304′ illustrated in FIG. 5.

As will be understood, once the call block record 29 is created, in general the incoming calls 40 matching the CLID 90 will be globally suppressed or call blocked by the system 10. This is illustrated by tracked call data record 25′ in FIG. 5, created after the telemarketer 304 has been added to the “call block” list 28. The tracked call record 25′ shows that the telemarketer's 304 call was rejected or call blocked, as indicated by the completed or disposition status 76 code “R”.

Alternatively (to Block 308), if the CLID 72 is not globally “white listed”, the call block module 34 may be programmed to create a call block record 29″ containing CLID 90 data matching the CLID 72 identified in Block 302 together with a client identifier 92 containing a grey-listing indicator (such as “GREY”) (Block 308A). As will be understood, a “grey listed” CLID 90 will not be call blocked, but has been flagged for further investigation as a potential telemarketer.

Periodically, the administrators of the system 10 will conduct further investigations into the “grey listed” call block records 29″, eg. by conducting telephone enquiries to verify if a “grey listed” CLID 90 is in fact a telemarketer (Block 310A). If a CLID 90 is determined not to be a telemarketer, the corresponding call block record 29 is deleted (Block 312A), and the call block module 34 continues searching for telemarketer calling patterns in Block 302.

Similarly, preferably, the administrators of the system 10 will also periodically conduct further investigations into the “black listed” call block records 29′, eg. by conducting telephone enquiries to verify if a “black listed” CLID 90 is still a telemarketer, since telephone numbers are reassigned on occasion. If a CLID 90 is determined not to be a telemarketer, the corresponding call block record 29′ is deleted

If a CLID 90 is found to be a telemarketer, the client identifier 92 for the corresponding call block record 29 is amended to contain a global call block indicator (such as “GLOBAL”) (Block 314A), thus adding it to the global black list, and the call block module 34 continues searching for the next telemarketer calling pattern in Block 302.

Referring now to FIG. 8C, this figure is a flow chart setting out another process 400 carried out by the system 10 to permit a client 52 to interact with the system 10 when certain calls 40 are received. Preferably, the system 10 will cause routed phone calls 40 to indicate either through a special ring tone or through a series of tones when the phone is “picked up” by the client 52 that the call 40 was originally made to a published number 54. Upon receipt of such a phone call 40 (Block 402), a client 52 may determine that the call 40 is or is not in response to its measured advertisement typically as a result of speaking with the caller 41 (Block 404). If the call 40 is in response to an advertisement 50, the call will simply be concluded in the ordinary course (Block 405).

However, if the call 40 is not in response to an advertisement 50, the client 52 may report this event in real time to the CMS 10 to flag the call 40 as invalid and/or place the calling party CLID 42 on the client's 52 individual call block list. Instructions are sent by the client 52 by pressing buttons on a touch-tone phone and transmitting a sequence of Dial Tone Modulation Frequency (DTMF) tones to the CMS 10 via the PSTN 17 (Block 406).

Those skilled in the art can appreciate how a sequence of DTMF tones can be interpreted as instructions by a telephony system. As an example, the client 52 may key in a determined DTMF sequence such as *#66 which would instruct the system 10 to block further calls from that CLID and remove that call from effectiveness reporting. If the DTMF tones are determined to be call block instructions (Block 408), the call block module 34 creates a call block record 29 (such as call block record 29′″) containing CLID 90 data matching the CLID 42, together with a client identifier 92 matching the client's 52 client identifier 60 (Block 410).

Preferably, the administrators of the system 10 will also periodically conduct further investigations into the individual client “black listed” call block records 29′″, eg. by conducting telephone enquiries to verify if an individual client “black listed” CLID 90 is a telemarketer and hence should be globally call blocked (Block 412). If a CLID 90 is found to be a telemarketer, the client identifier 92 for the corresponding call block record 29′″ is preferably amended to contain a global call block indicator (such as “GLOBAL”) (Block 414).

Alternatively, the advertiser may key in a DTMF combination such as *#67, which would not block future calls, but would remove the call from the effectiveness reporting. Upon receipt of removal from effectiveness reporting instructions, the call block module 34 instructs the routing module 32 to modify the tracked call record 25 in the call tracking database 24 created in Block 224, to store data corresponding to the disposition of the call 40 indicating that the call was not in response to the advertising initiative (Block 416).

Preferably, the CMS 10 is configured and programmed to permit a client 52 to access and manipulate the individual client's 52 “white list” 27′″ and “black list” 29′″ data via the Internet 18 using TCP/IP. The client 52 may access the call block module 34 via the hypertext transport protocol in a secure or unsecured method (HTTP/HTTPS). The call block module 34 is preferably configured to provide a user interface to manage such lists 27′″, 29′″. The interface preferably allows the client 52 the option to add, change, or remove calling party CLIDs from the client's 52 white list 27′″ or the client's 52 individualized black list 29′″. Those skilled in the art can appreciate how a web service can provide forms that interact with a database.

Thus, while what is shown and described herein constitute preferred embodiments of the subject invention, it should be understood that various changes can be made without departing from the subject invention, the scope of which is defined in the appended claims.

1. A call measurement system, comprising:
(a) a routing system configured to receiving an incoming call comprising incoming call data, wherein the incoming call data may include an original dialed number and a caller identifier;
(b) a client database storing:
(i) at least one published number; and
(ii) at least one termination number, wherein each termination number corresponds to at least one published number;
(c) a call block database storing at least one blocked number; and
(d) wherein the routing system is operatively coupled to the client database and to the call block database and wherein the routing system is configured to route the incoming call to one of the termination numbers.

2. A call measurement system as claimed in claim 1, wherein the routing system is configured to compare the caller identifier data to the at least one blocked number and wherein if the caller identifier data corresponds to a blocked number, the routing system is configured to terminate the incoming call.

3. A call measurement system as claimed in claim 1, further comprising a reporting system, wherein the reporting system includes a call tracking database storing incoming call data.

4. A call measurement system as claimed in claim 1, wherein the call block database stores globally blocked numbers and individually blocked numbers and wherein each individually blocked number corresponds to a specific termination number.

5. A method of routing incoming calls comprising incoming call data, wherein the incoming call data includes, original dialed number data and caller identifier data, the steps of the method comprising:
(a) providing a client database storing:
(i) at least one published number; and
(ii) at least one termination number, wherein each termination number corresponds to at least one published number;
(b) providing a call block database storing call block data corresponding to at least one blocked number;
(c) receiving at least one incoming call comprising incoming call data, wherein the incoming call data includes an original dialed number and a caller identifier; and
(d) comparing the caller identifier data to the call block data and if the caller identifier data does not correspond to a blocked number, routing the incoming call to a termination number.

6. The method of claim 5, wherein step (c) comprises comparing the original dialed number to the at least one published number.

7. The method of claim 6, wherein step (d) further comprises routing the incoming call to the termination number corresponding to a published number which matches the original dialed number.

8. The method of claim 5 further comprising the steps of:
(e) storing incoming call data for each incoming call, in a call tracking database;
(f) searching the incoming call data in the call tracking database to locate a telemarketing calling pattern; and
(g) wherein if a telemarketing pattern is located, for at least one caller identifier corresponding to the telemarketing pattern storing a corresponding blocked number in the call block database.

9. A method of creating a call block database comprising the following steps:
(a) providing a client database storing:
(i) a plurality of published numbers; and
(ii) a plurality of termination numbers, wherein each termination number corresponds to at least one published number;
(b) providing a call block database configured to store at least one blocked number;
(c) receiving a plurality of incoming calls comprising incoming call data, wherein the incoming call data includes an original dialed number and a caller identifier;
(d) storing incoming call data for each incoming call, in a call tracking database; and
(e) searching the incoming call data in the call tracking database to locate telemarketing calling patterns.

10. The method of creating a call block database as claimed in claim 9, wherein step (e) further comprises checking the incoming call data in the call tracking database for multiple incoming calls having the same caller identifier.

11. The method of creating a call block database as claimed in claim 10, wherein step (e) further comprises for those multiple calls having the same caller identifier:
(i) determining if the incoming call data corresponding to the multiple calls includes more than one original dialed number.

12. The method of creating a call block database as claimed in claim 9, further comprising the following step:
(f) wherein if a telemarketing pattern is located, for at least one caller identifier corresponding to the telemarketing pattern storing a corresponding blocked number in the call block database.

13. The method of creating a call block database as claimed in claim 12, further comprising the following step:
(g) investigating to confirm if the at least one caller identifier corresponds to a telemarketer.

14. The method of creating a call block database as claimed in claim 13, further comprising the following step:
(h) wherein if the at least one caller identifier does not correspond to a telemarketer, deleting the corresponding blocked number from the call block database.

15. The method of creating a call block database as claimed in claim 12, further comprising periodically deleting blocked numbers from the call block database.

16. The method of creating a call block database as claimed in claim 15, further comprising investigating to confirm if at least one blocked number in the call block database corresponds to a telemarketer.

17. The method of creating a call block database as claimed in claim 16, further comprising the following step:
(a) wherein if the at least blocked number does not correspond to a telemarketer, deleting the blocked number from the call block database.

18. A call block database created in accordance with the method of claim 12.

19. A call measurement system comprising a call block database created in accordance with the method of claim 12.
